(19) United States
(12) Patent Application Publication
(10) Pub. No.: US 2012/0167153 A1
(43) Pub. Date: Jun. 28, 2012

(54) SYSTEM FOR PROVIDING BROADCAST SERVICE AND METHOD FOR PROVIDING BROADCAST SERVICE

(75) Inventors: Pum Mo RYU, Daejeon (KR); Myung Gil Jang, Daejeon (KR); Ji Ae Shin, Daejeon (KR); Hyun Ki Kim, Daejeon (KR); Mi Ran Choi, Daejeon (KR); Soo Jong Lim, Daejeon (KR); Chung Hee Lee, Daejeon (KR); Jeong Heo, Daejeon (KR); Hyo Jung Oh, Daejeon (KR); Chang Ki Lee, Daejeon (KR); Yeo Chan Yoon, Seoul (KR); Yoon Jae Choi, Gangwon-do (KR); Sang Kyu Park, Daejeon (KR)

(73) Assignee: ELECTRONICS AND TELECOMMUNICATIONS RESEARCH INSTITUTE, Daejeon (KR)

(21) Appl. No.: 13/326,802

(22) Filed: Dec. 15, 2011

(30) Foreign Application Priority Data
Dec. 23, 2010 (KR) 10-2010-0134032

(51) Int. Cl. H04N 21/00

(52) U.S. Cl. 725/109

(57) ABSTRACT

Disclosed are a system for providing a broadcast service and a method for providing a broadcast service. An example of the method for providing a broadcast service includes receiving a broadcast signal including broadcast contents and side information to provide the broadcast contents; reading out at least one of objects from question data that is input regarding the broadcast contents and primarily analyzing the read-out object to read out a subject of the question data; searching a social media site and collecting social media data relating to the subject from the searched social media site; secondarily analyzing the social media data and the side information in the broadcast signal on the basis of the subject; and configuring answer data corresponding to the subject using the analysis result and providing the answer data, and provides information which is extended and varied in real time.

### CROSS-REFERENCE TO RELATED APPLICATIONS

This application claims priority to and the benefit of Korean Patent Application No. 10-2010-0134032 filed in the Korean Intellectual Property Office on Dec. 23, 2010, the entire contents of which are incorporated herein by reference.

### TECHNICAL FIELD

The present invention relates to a system for providing a broadcast service and a method for providing a broadcast service. More specifically, the present invention relates to a system for providing a broadcast service and a method for providing a broadcast service that is capable of providing a broadcast service including an active and intelligent response based on information, which are varied and extended in real time, in response to the request from a viewer by analyzing reviews from a related social media site and searching out issues, compared with a prior-art broadcast service that provides simple information, which are previously fixed, in response to the request from the viewer.

### BACKGROUND

Even though the prior-art broadcast service provides side information regarding broadcast contents, the service environment is mainly unidirectional from a broadcasting station to a broadcasting receiver. Accordingly, it is difficult to provide side information that is not provided by the broadcasting station to the viewers.

Further, even in the bidirectional relationship between the broadcasting station and the broadcasting receiver, the broadcasting station can provide only previously determined, that is, fixed side information with regard to the broadcast contents. Therefore, the bidirectional relationship entirely depends on the broadcasting station.

As a result, under the broadcast service environment according to the prior art, there are some problems in that the demands by viewers cannot be satisfied because only the fixed side information can be provided. Further, since the side information is fixed, it is difficult to provide side information that is actively extended and varied in real time.

### SUMMARY

The present invention has been made in an effort to provide a system for providing a broadcast service and a method for providing a broadcast service providing a broadcast service that is capable of satisfying various demands by viewers for broadcast contents and includes not fixed side information, but responses that are actively extended and varied in real time, in response to the various demands of the viewers.

An exemplary embodiment of the present invention provides a method for providing a broadcast service that provides information, which is extended and varied in real time, the method including: receiving a broadcast signal including broadcast contents and side information to provide the broadcast contents; reading out at least one of objects from question data that is input regarding the broadcast contents and primarily analyzing the read-out object to read out a subject of the question data; searching a social media site and collecting social media data relating to the subject from the searched social media site; secondarily analyzing the social media data and the side information in the broadcast signal on the basis of the subject; and configuring answer data corresponding to the subject using the analysis result and providing the answer data.

The method may further includes categorizing and providing the searched social media site; and selecting at least one social media site from the provided list of social media sites.

The subject may be read out by further determining at least one of a type of the read-out objects, a category, restrictions on the object, and a type of the answer.

The provided broadcast service may be performed using a cloud computing technology in a cloud or a server.

The format of the question and answer data may be at least one of a text, voice or audio, a gesture, a video, and an image or a combined conversation type of two or more thereof.

Means for inputting the question data may be at least one of a remote controller, a local key, a keyboard, a microphone for inputting voice or audio, a smart phone, a mouse, a touch pad, a gesture inputting device, and a pointer or a combination of two or more thereof.

The social media data may includes at least one of an issue relating to the read-out subject, review information, and information including words equal or similar to the subject.

The method may further includes storing the collected social media data as a database.

The social media data may be made as a database based on at least one of a date, a day, a time, an issue, a genre, and a format.

Another exemplary embodiment of the present invention provides a system for providing a broadcast service including: a digital television receiver configured to receive a broadcast signal including broadcast contents and side information, provide the broadcast contents, output question data that is input regarding the broadcast contents, and receive and provide answer data corresponding to the question data; and a server including: an analyzing unit configured to read out at least one of objects from the question data, primarily analyze the read-out object, and read out a subject of the question data from the read-out object through the primary analysis; a searching unit configured to search a social media site; a processing unit configured to collect social media data relating to the read-out subject from the searched social media site and secondarily analyze the social media data and the side information extracted from the broadcast signal on the basis of the subject to configure and output answer data corresponding to the subject using the analysis result.

The searching unit may categorizes and provides the searched social media site, and the processing unit may selects at least one social media site from the provided list of social media sites.

The server may provides the broadcast service using a cloud computing technology.

The analyzing unit may further determines at least one of a type of the read-out objects, a category, restrictions on the object, and a type of the answer to read out the subject.

The format of the question and answer data may be at least one of a text, voice or audio, a gesture, a video, and an image or a combined conversation type of two or more thereof.

Means for inputting the question data may include at least one of a remote controller, a local key, a keyboard, a microphone for inputting voice or audio, a smart phone, a mouse, a touch pad, a gesture inputting device, and a pointer or a combination of two or more thereof.

The social media data may includes at least one of an issue relating to the read-out subject, review information, and information including words equal or similar to the subject.

The server may further includes: a storing unit configured to store the collected social media data as a database.

The storing unit may makes the social media data as a database based on at least one of a date, a day, a time, an issue, a genre, and a format.

According to exemplary embodiments of the present invention, the following advantages can be obtained:

First, it is possible to satisfy various demands of viewers for broadcast contents.

Second, it is possible to provide a broadcast service that includes not fixed side information, but responses that are extended and varied in real time in response to the various demands of the viewers for the broadcast contents.

Third, it is possible to improve the satisfaction of the viewers by providing a broadcast service including conversation type information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram illustrating an overall broadcast service environment.

FIG. 2 is a schematic diagram illustrating an example of a broadcast service providing system according an exemplary embodiment of the present invention.

FIGS. 3A and 3B are detailed configuration block diagrams showing a digital television receiver shown in FIGS. 1 and 2.

FIG. 4 is a detailed configuration block diagram showing an example of an intelligent information processing module according to an exemplary embodiment of the present invention.

FIGS. 5 to 8 are diagrams illustrating examples of scenarios that are used in a broadcast service providing system for intelligently processing information according to an exemplary embodiment of the present invention.

FIG. 9 is a flowchart showing an example of a broadcast service providing method according an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. Further, in the description of this invention, if it is determined that the detailed description of the configuration or function of the related art may unnecessarily deviate from the gist of the present invention, the detailed description of the related art will be omitted. Hereinafter, preferred embodiment of this invention will be described. However, the technical idea is not limited thereto, but can be modified or performed by those skilled in the art.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

In the following description, the suffixes “module” and “unit” for each element is used to easily describe the invention, and thus “module” and “unit” can be used with mixed manner.

A digital broadcast receiver of this specification includes an intelligent smart TV, a network TV, and an IPTV (Internet Protocol TV) in which a computer supporting function is added to a broadcast receiving function. In some case, a smart phone may be included. Further, the digital broadcast receiver has a broadcast receiving function to which an Internet function is added, and may equip a convenient interface such as various kinds of input device, a touch screen, or a space remote controller. Further, by supporting a wired or wireless Internet function, with access to the Internet and a computer, functions such as e-mail, web browsing, online banking, or online games can also be performed. For the above various functions, a standardized general purpose operating system can be used.

Therefore, according to the digital broadcast receiver of this invention, since various applications can be freely added or removed to or from the general purpose OS kernel, it is possible to perform various viewer friendly functions. However, in the following description, the term “digital television receiver” will be used and the digital television receiver may include a set-top box (STB) and a display.

Hereinafter, the exemplary embodiment of the present invention will be described with reference to the accompanying drawings.

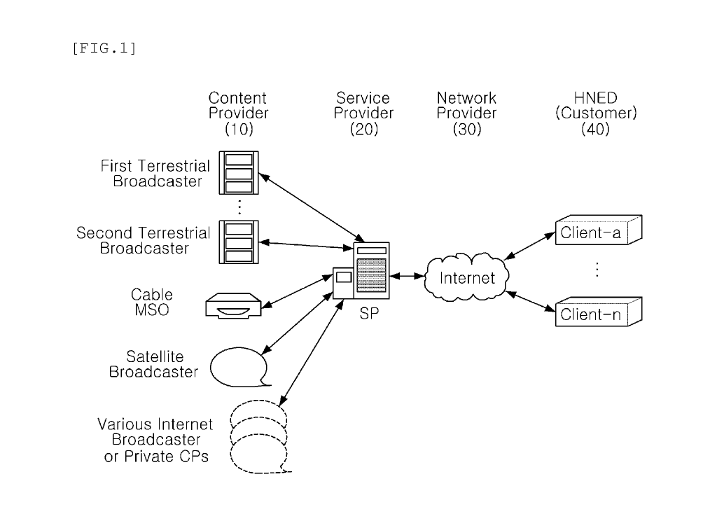

FIG. 1 is a schematic diagram illustrating an overall broadcast service environment.

The overall broadcast service environment or system includes a content provider (CP) 10, a service provider (SP) 20, a network provider (NP) 30, and a HNED (customer) 40. Here, the HNED 40 refers to a group of a plurality of clients 100, and each client 100 corresponds to a digital television receiver equipped in individual homes.

The content provider 10 produces and provides various contents. Here, the content provider 10 may include at least one of a terrestrial broadcaster, a cable system operator (SO), or an MSO (Multiple System Operator), a satellite broadcaster, various Internet broadcasters or a private broadcaster (CP). Further, the content provider 10 may provide various applications other than broadcast contents.

The service provider 20 makes the contents provided by the content provider 10 as a service package and provides the package. For example, the service provider 20 packages a first terrestrial broadcast, a second terrestrial broadcast, a cable MSO, a satellite broadcast, various Internet broadcasts, and applications and provides the package to a viewer 40 through a network.

The service provider 20 can provide the packaged service to the client 100 through a network in a unicast/multicast manner. The unicast manner refers to a transmission method that transmits data one-to-one between a single transmitter and a single receiver. For example, if the broadcast receiver requests data to a server, the server can transmit the data to the receiver in response to the request. Further, the multicast manner refers to a transmission method that transmits data to multiple receivers of a specific group. According to the multicast manner, the server can transmit data to a plurality of previously registered receivers at one time. In order to register such multicast, IGMP (Internet Group Management Protocol) can be used.

In the above description, even though the content provider 10 and the service provider 20 are described as independent entities, each entity may include a function of the other entity to operate as one entity. For example, the service provider 20 has a function as a content provider 10 to produce the contents and package the service and provide the package to the HNED 40.

The network provider 30 provides a network to provide a service to the client 100.

The client 100 establishes a home network (home network end user: HNED) to receive the service. The client 100 may further include modules such as a cable card or a DCAS (Downloadable Conditional Access System) for conditional access or content protection in order to protect transmitted contents. The client 100 can provide contents through the network. In this case, inversely, the client 100 can be a content provider, and the content provider 10 may receive contents from the client 100. With this design, it is possible to provide bidirectional content service or data service.

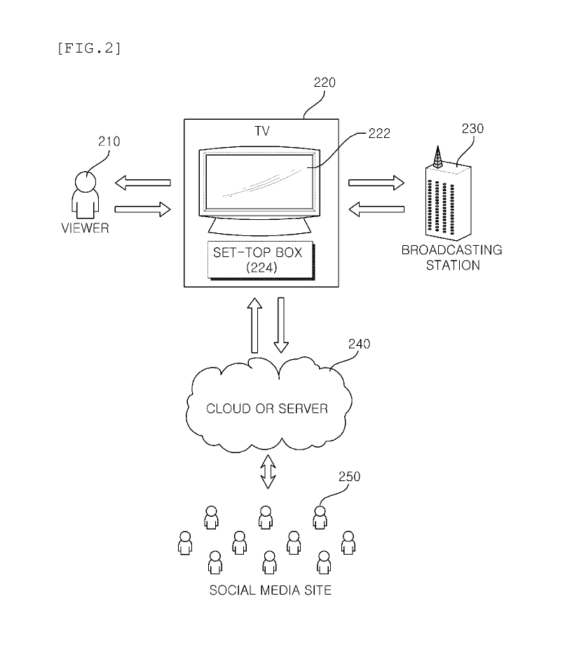

FIG. 2 is a schematic diagram illustrating an example of a broadcast service providing system according an exemplary embodiment of the present invention.

Referring to FIG. 2, the example of the broadcast service providing system according to an exemplary embodiment of the present invention includes a viewer 210, a digital television receiver 220, a broadcasting station 230, a cloud or a server 240, and a media 250.

Specifically, in order to process the broadcast service, the digital television receiver 220 receives a broadcasting signal including broadcast contents and side information, provides the broadcast contents, outputs question data input with regard to the broadcast contents, and receives and provides answer data corresponding to the question data. The cloud or the server 240 reads out at least one object from the question data, analyzes the read object to read out the subject of the question data. Further, the cloud or the server 240 searches a social media site and collects social media data relating to the theme from the searched social media site, and analyzes the side information extracted from the social media data and the broadcasting signal on the basis of the subject to configure and output the answer data corresponding to the subject from the analyzed result.

The broadcasting station 230 provides broadcast contents and side information regarding the broadcast contents to the digital television receiver 220. The broadcasting station 230, for example, can be a content provider 10 or/and a service provider 20 shown in FIG. 1.

The digital television receiver 220 basically receives broadcasting signals including broadcast contents and side information thereof from the broadcasting station 230. The digital television receiver 220 provides the broadcast contents included in the received broadcasting signal and separately stores the side information.

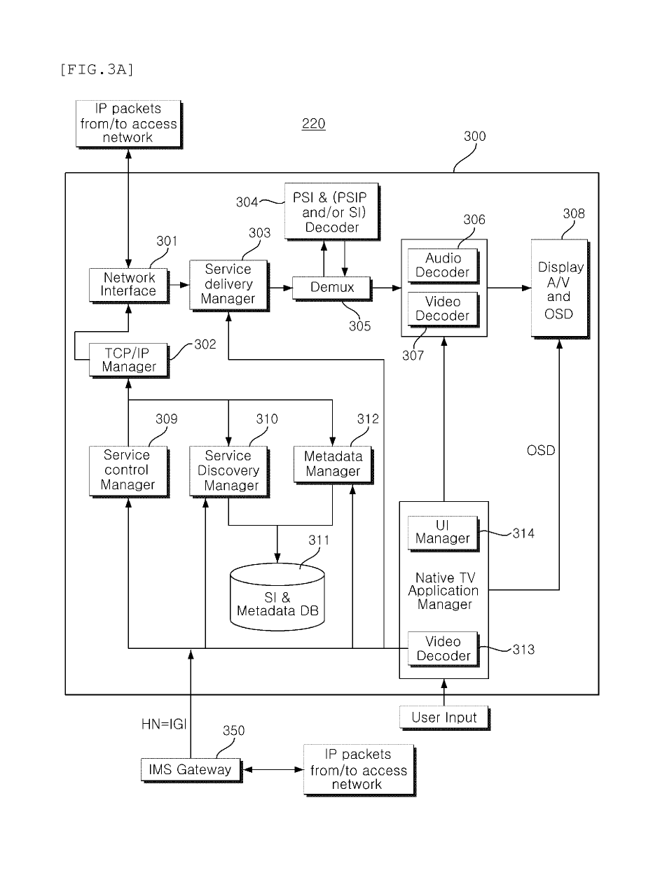

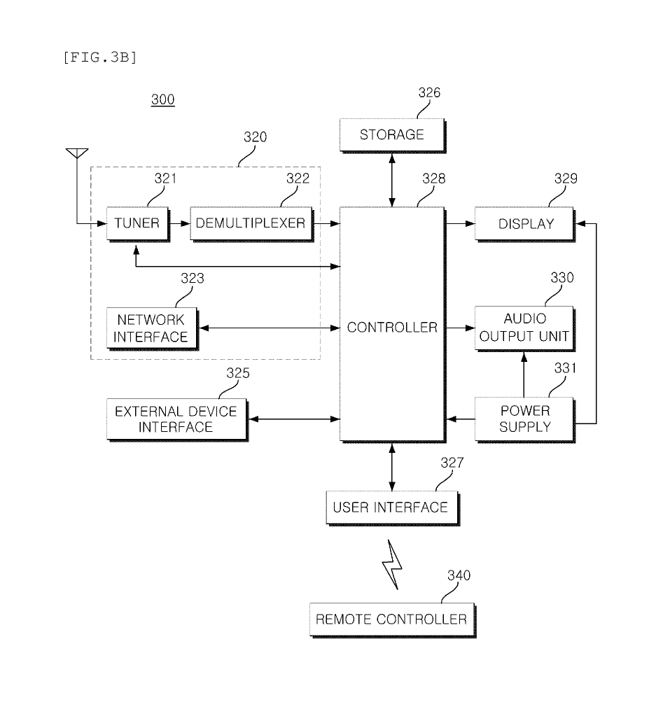

The digital television receiver 220 may include components required to process various broadcasting signals according to broadcasting media. As shown in FIG. 2, the digital television receiver 220 may include a set-top box (STB) 224 and a display device 222. Here, the set-top box (STB) 224 is a main module that processes an actual broadcasting signal and various input data, and the configuration and description thereof will be made in detail with reference to FIG. 3. Therefore, the description of the set-top box will be omitted here.

The media 250 refers to a social media site. Hereinafter, the social media site 250 may include any kinds of Internet spaces in which viewers can freely write and read comments such as their own experiences, opinions, and reviews. Examples of the social media site 250 may include a social network such as Twitter and Facebook, blog, Internet café, board, or replies of various portal sites.

Hereinafter, referring to FIG. 2, the broadcast service providing system according to an exemplary embodiment will be described.

The broadcast service according to the exemplary embodiment means a broadcast service that satisfies various demands of viewers. Further, the broadcast service also includes responses that are actively extended and varied in real time, not fixed side information, in response to the various demands by a viewer. Therefore, hereinafter, the broadcast service according to the exemplary embodiment is referred to as intelligent information processing.

If a viewer 210 requests specific broadcast contents, the requested broadcast contents are provided through the digital television receiver 220. In this case, the viewer 210 can ask questions including various requests concerning the provided broadcast contents other than the broadcast contents request.

If the question from the viewer 210 is input, the digital television receiver 220 transmits the input question to a cloud or a server 240 on a connected network.

The cloud or server 240 analyzes the questions of the viewer 210 transmitted from the digital television receiver 220, configures the answers corresponding to the analyzed questions, and transmit the answers to the digital television receiver 220. In this case, the cloud or server 240 searches at least one of related social media site 250 on the basis of the analyzed questions and collects data for answers relating to the analyzed questions from the searched social media site 250. The collected data may be separately stored or transmitted to a controller to configure answer data. In this process, the cloud or server 240 receives side information concerning contents that is an object of the questions from the digital television receiver 220 and uses the information to configure the answer data.

The digital television receiver 220 creates OSD (On-Screen Display) data based on the answer data provided from the cloud or server 240 to provide the OSD data to the viewer 210 through the display device 222, which allows to respond in a conversational mode to the questions of the viewer 210 by using an intelligent information processing.

The above-described example is an example of a scenario relating to a broadcast service providing method according to an exemplary embodiment of the present invention, but the broadcast service providing method according to an exemplary embodiment of the present invention is not limited thereto.

For example, further questions connected to primary questions or answers or additional questions of another viewer may exist.

As another example of the broadcast service providing method according to an exemplary embodiment of the present invention, a viewer 210 may request direct access to the social media site 250 in order to state the opinion relating to broadcast contents that the viewer is currently watching or communicate with other viewers. In this case, the digital television receiver 220 may directly access the social media site that is requested by the viewer or searches the related social media site using the cloud or server 240 and provides the related screens to allow the viewer to access.

FIGS. 3A and 3B are detailed configuration block diagrams showing the digital television receiver shown in FIGS. 1 and 2.

Referring to FIG. 3A, the digital television receiver 300 includes a network interface 301, a TCP/IP manager 302, a service delivery manager 303, a demultiplexer 305, a SI (System Information) decoder 304, an audio decoder 306, a video decoder 307, a display A/V and OSD module 308, a service control manager 309, a service discovery manager 310, a metadata manager 312, an SI & metadata storage 311, an UI (User Interface) manager 314, and a service manager 313. However, the digital television receiver 300 according to the exemplary embodiment may omit some of the above-described elements or add some elements if needed.

The network interface 301 receives packets including broadcast signals received from a network or transmits packets through the network. The network interface 301 receives services, contents, and side information relating to the contents from a service provider through the network.

The TCP/IP manager 302 involves the transmission of the packets from a source to a destination, that is, a packet received by the digital television receiver 300 and a packet transmitted from the digital television receiver 300. With regard to this, the TCP/IP manager 302 classifies the received packets so as to correspond to appropriate protocol, and outputs the classified packets to the service delivery manager 303, the service discovery manager 310, the service control manager 309, and the metadata manager 312.

The service delivery manager 303 controls the received service data. For example, when the service delivery manager 303 controls real-time streaming data, a RTP/RTCP may be used. If the real-time streaming data is transmitted using a RTP, the service delivery manager 303 parses the received data packet in accordance with the RTP to transmit the data packet to the demultiplexer 305, or store the data packet into the SI & Metadata storage 311 in accordance with the control of the service manager 313. The service delivery manager 303 uses the RTCP to feedback the network reception information to a server that provides a service.

The demultiplexer 305 demultiplexes the received packets into audio, video, or SI data to transmit the packets to the audio decoder 306, the video decoder 307, and the SI decoder 304. Here, the packets may be received in DSM-CC or data carousel manner.

The SI decoder 304 decodes service information including the SI data. Here, the SI data may include North American PSI/PSIP (Program Specific Information/Program and System Information protocol) section data or European SI (Service Information) section data. Further, the SI decoder 304 decodes the received sections to create database regarding the service information, and the database regarding the service information is stored in the SI & Metadata storage 311.

The audio decoder 306 and the video decoder 307 decode the audio data and the video data received from the demultiplexer 305. The audio data decoded in the audio decoder 306 and the video data decoded in the video decoder 307 are provided to the viewer through the display 308.

The service manager 313 and the UI manager 314 manage the overall status of the digital television receiver 300, provide the viewer interface, and manage the other managers.

The UI manager 314 provides a graphic user interface (GUI) for a viewer using an OSD, and receives key input from the viewer to operate as a receiver in response to the input. For example, if the viewer inputs a key to select a channel, a key input signal is transmitted to the service manager 313.

The service manager 313 controls managers relating to a service, such as the service delivery manager 303, the service discovery manager 310, the service control manager 309, and the metadata manager 312. The service manager 313 creates a channel map and selects a channel using the channel map according to the key input received from the viewer interface manager 314. The service manager 313 receives service information of the channel from the SI decoder 304 to set an audio/video PID (Packet Identifier) of the selected channel to the demultiplexer 305.

The service discovery manager 310 provides information required to select a service provider that provides a service. If the service discovery manager 310 receives a signal relating to the channel selection from the service manager 313, the service discovery manager 310 discovers a service using the information.

The service control manager 309 selects and controls the service. For example, if a viewer selects a live broadcasting service that uses a known broadcasting method, the service control manager 309 uses IGMP or RTSP to select and control the service. In contrast, if the viewer selects a service such as VOD (Video On Demand), the service control manager 309 uses RTSP to select and control the service. In the above description, the RTSP protocol may provide a trick mode with regard to the real-time streaming.

The service control manager 309 uses IMS (IP Multimedia Subsystem) or SIP (Session Initiation Protocol) to initialize and manage a session that passes through an IMC gateway. The above-mentioned protocols are only examples, and another protocol may be used according to embodied examples.

The metadata manager 312 manages metadata relating to a service, and stores the metadata into the SI & Metadata storage 311.

The SI & Metadata storage 311 stores service information decoded by the SI decoder 304, metadata managed by the metadata manager 312, and information required to select a service provider that is provided by the service discovery manager 310. Further, the SI & Metadata storage 311 may store set-up data for a system. The SI & Metadata storage 311 may be embodied by using a nonvolatile memory (Nonvolatile RAM: NRAM) or a flash memory.

In the meantime, the IG 350 is a gateway in which functions required to access an IPTV service based on IMS are collected.

FIG. 3B shows another example of the digital television receiver 300 of FIG. 3A.

Referring to FIG. 3B, another example of a digital television receiver 300 according to the exemplary embodiment includes a broadcast receiver 320, an external device interface 325, a storage 326, a viewer input interface 327, a controller 328, a display 329, an audio output unit 330, a power supply 331, and a capturing unit (not shown).

The broadcast receiver 320 may include a tuner 321, a demultiplexer 322, and a network interface 323.

The tuner 321 selects an RF broadcasting signal corresponding to a channel selected by the viewer or all channels that are previously stored, among RF (Radio Frequency) broadcast signals received through an antenna. Further, the tuner 321 converts the selected RF broadcast signal into a medium frequency signal or a baseband video or an audio signal. Furthermore, the tuner 321 can receive a single carrier RF broadcast signal according to an ATSC (Advanced Television System Committee) standard or a multi carrier RF broadcast signal according to a DVB (Digital Video Broadcasting) standard.

The demultiplexer 322 demultiplexes the broadcast signal received by the tuner 321. For example, if the broadcast signal output from the tuner 321 is a signal according to the ATSC standard, the demultiplexer 322 performs 8-VSB (8-Vestigal Side Band) demultiplexing. In contrast, if the broadcast signal output from the tuner 321 is a signal according to the DVB standard, the demultiplexer 322 performs COFDMA (Coded Orthogonal Frequency Division Modulation) demultiplexing. Further, the demultiplexer 322 may output a stream signal (TS) after demultiplexing and channel decoding. In this case, the stream signal may be a signal in which a video signal, an audio signal, or a data signal is multiplexed. For example, the stream signal may be an MPEG-2 TS (Transport Stream) in which an MPEG-2 standard video signal or a Dolby AC-3 standard audio signal is multiplexed. In the meantime, the demultiplexer 322 may be separately provided so as to correspond to the ATSC standard and the DVB standard, respectively.

The stream signal output from the demultiplexer 322 may be input to the controller 170. The controller 328 performs demultiplexing and video/audio signal processing, and then outputs the video and the audio to the display 329 and the audio output unit 330, respectively.

The external device interface 325 connects external devices with the digital television receiver 300. For this connection, the external device interface 325 may include an A/V input/output unit (not shown) or a wireless communicating unit (not shown). In the above description, for example, the external devices may include wire/wireless connectable devices such as a DVD (Digital Versatile Disk), a Blu-ray, a game machine, a camera, a video camera, and a computer (laptop computer). The external device interface 325 transmits a video, audio or a data signal, which is input from the outside through a connected external device, to the controller 328 of the digital television receiver 300. Further, the interface 325 may output the video, audio, or data signal, which are processed in the controller 328, to the connected external device. The A/V input/output unit may include a USB port, a CVBS (Composite Video Banking Sync) port, a component port, an S-video port (analog), a DVI (Digital Visual Interface) port, an HDMI (High Definition Multimedia Interface) port, a RGB port, and a D-SUB port in order to input the image and the audio signal of the external device to the digital television receiver 300. The wireless communicating unit can perform near field wireless communication with another electronic device. Here, the digital television receiver 100 may be connected with another electronic device through a network according to a communication protocol such as a Bluetooth, RFID (Radio Frequency Identification), IrDA (Infrared Data Association), UWB (Ultra Wideband), ZigBee, or DLNA (Digital Living Network Alliance).

The external device interface 325 is connected with various set-top boxes through at least one of the above-described various ports to perform the input/output operation with the set-top box. In the meantime, the external device interface 325 receives applications in adjacent external devices or an application list to transmit the application or the application list to the controller 328 or the storage 326.

The network interface 323 provides an interface to connect the digital television receiver 300 to a wired/wireless network including an Internet network. The network interface 323 may include an Ethernet port for connecting with a wired network, and may use WLAN (Wireless LAN: WiFi), Wibro (Wireless broadband), Wimax (World Interoperability for Microwave Access), or HSDPA (High Speed Downlink Packet Access) communication protocol for connecting with a wireless network.

The network interface 323 may receive/transmit data with another viewer or another electronic device through the connected network or another network that is linked to the connected network. In the meantime, the network interface 323 may access a predetermined web page through the connected network or another network that is linked to the connected network. In other words, the network interface 323 accesses a predetermined web page through the network to transmit/receive data to/from the corresponding server and to receive contents or data that are provided by the content provider or a network operator. Specifically, it is possible to receive contents such as movies, advertisements, games, VOD, or broadcast signals and information related thereto provided by the content provider or the network provider through the network. Further, the network interface 323 can receive update information and update files of a firmware that is provided by the network operator. Furthermore, the network interface 323 may transmit data to an Internet or content provider or a network operator.

The storage 326 may store a program for processing and controlling signals in the controller 328 or a signal processed video, audio, or a data signal. The storage 326 may include at least one kind of recording medium including a flash memory type, a hard disk type, a multimedia card micro type, a card type memory (for example, SD or XD memory), a RAM, and a ROM (EEPROM). The digital television receiver 300 reproduces a contents file stored in the storage 326 (a motion video file, a still video file, an audio file, a text file, an application file, etc.) to transmit the reproduced contents file to the viewer.

The viewer input interface 327 transmits the signal input by the viewer to the controller 328 or transmits the signal from the controller 328 to the viewer.

For example, the viewer input interface 327 receives and processes a control signal such as power on/off, channel selection, or screen setting from the remote controller 340 according to various communication method such as the RF (Radio Frequency) communication method or IR (Infrared) communication method. Further, the viewer input interface 327 may process the control signal from the controller 328 to be transmitted to the remote controller 340.

For example, the viewer input interface 327 may send a control signal, which is input from a local key (not shown) such as a power key, a channel key, a volume key, or a set value, to the controller 328.

The viewer input interface 327 may send a control signal that is input from a sensor (not shown) sensing a gesture of a viewer to the controller 328 or transmit a signal from the controller 328 to the sensor (not shown). Here, the sensor (not shown) may include a touch sensor, a voice sensor, a position sensor, or a motion sensor.

The controller 328 may control the overall operation in the digital television receiver 300. Further, the controller 328 may control the digital television receiver 300 according to a command of a viewer input through the viewer input interface 327 or an internal program. Specifically, the controller 328 accesses the network to allow the viewer to download an application or an application list that the viewer wants into the digital television receiver 300. For example, the controller 328 controls the tuner 321 so that a signal of a channel that is selected by a predetermined channel selection command received through the viewer input interface 327 is input and processes the video, audio, or data signal of the selected channel. The controller 328 allows the channel information selected by the viewer to be output through the display 329 or the audio output unit 330 together with the processed video or audio signal.

According to another example, the controller 328 allows a video signal or an audio signal from an external device such as a camera or a video camera, which is input through the external device interface 325, to be output to the display 329 or the audio output unit 330 according to an external device video reproducing command received through the viewer input interface 327.

The controller 326 may control the reproduction of contents. In this case, the contents may be contents stored in the digital television receiver 300 received broadcast contents, or external input contents input from the outside. The contents may be at least one of a broadcasting video, an external input video, an audio file, a still video, a n accessed web screen, and a text file.

According to the exemplary embodiment, the controller 326 may receive the question data of the viewer through the viewer interface 327, figure out the input question data, and transmit the figured out question data to the cloud or server 240. Further, if answer data is transmitted from the cloud or server 240 in response to the transmission, the controller 326 may control a series of processes of providing the data to the viewer.

The display 329 converts the video signal, the data signal, the OSD signal, which are processed in the controller 328, or a video signal, which is received by the external device interface 325, or a data signal into R, G, or B signals to generate a driving signal. The display 329 may be a PDP, an LCD, an OLED, a flexible display, or a three-dimensional display. In the meantime, the display 329 may be configured by a touch screen so as to be served as an input device other than an output device.

The audio output unit 330 receives an audio-processed signal, that is, a stereo signal, a 3.1 channel signal, or a 5.1 channel signal from the controller 328 to output the audio-processed signal as audio. The audio output unit 330 may be embodied by various types of speakers.

In order to sense the gesture of the viewer, as described above, a sensor (not shown) including at least one of the touch sensor, the voice sensor, the position sensor, and the motion sensor may be added to the digital television receiver 300. The signal sensed by the sensor (not shown) may be sent to the controller 328 through the viewer input interface 327.

A capturing unit (not shown) that captures the viewer can be added. The information of video captured by the capturing unit (not shown) may be input to the controller 328.

The controller 328 may use the video captured by the capturing unit (not shown), or a signal sensed by the sensor (not shown) or combine the video and the signal to sense the gesture of the viewer.

The power supply 331 supplies power to the entire digital television receiver 300.

The remote controller 340 transmits the viewer's input to the viewer input interface 150. For this transmission, the remote controller 340 may use a Bluetooth, an RF communication, an IR communication, an UWB (Ultra Wideband), or ZigBee.

The remote controller 340 receives the video, audio, or data signal output from the viewer input interface 327, and displays the received video, audio, or data signal on the remote controller 340 or outputs to in voice or vibration.

The above-described digital television receiver 300 may be a fixed type digital broadcasting receiver that is capable of receiving at least one of ATSC type (8-VSB type) digital broadcast, DVB-T type (COFDM type) digital broadcast, and ISDB-T type (BST-OFDM type) digital broadcast.

The block diagrams of the digital television receiver 300 shown in FIGS. 3A and 3B illustrate the exemplary embodiment of the present invention, and the components of the block diagrams may be combined, added, or omitted according to the specifications of the embodied digital television receiver 300. In other words, two or more components may be combined into a single component, or a single component may be divided into two or more components, if necessary. Further, the function performed by each block is just illustrative, and the specific operation or devices does not limit the scope of the present invention.

FIG. 4 is a detailed configuration block diagram showing an example of an intelligent information processing module according to an exemplary embodiment of the present invention. Here, the intelligent information processing module includes a plurality of components for processing intelligent conversation between a viewer and a digital television receiver based on an analyzed result regarding broadcast contents and social media site.

Hereinafter, it is described that the intelligent information processing module is included in the cloud or server 240 shown in FIG. 2 and provides a broadcast service through the intelligent conversation processing using a cloud computing technology.

As described above, the questions and the answers between the viewer and the digital television receiver may be provided using a conversation form. The conversation form may include various types of communication between two entities, for example, a text, voice or audio, a gesture, a video, and an image. Further, the conversation form may further include indication or touch of a specific object, or selection of a specific object from a list of a plurality of objects. In the above instance, object information may be provided from SI information provided from a transmission terminal according to a predetermined broadcasting standard.

Input means for conversation between two entities may include various input means that are capable of communicating between two entities or transmitting a signal from one entity to the other entity, for example, a remote controller, a local key, a keyboard, a microphone for inputting voice or audio, and a smart phone. The input means may further include a mouse, a touch pad, a gesture input device, or a pointer.

Hereinafter, for the convenience of understanding and description, the description will be made using a text as an example of conversation form and a remote controller including an input unit for inputting the text as an example of the input means. However, this invention is not limited to the above examples, but it will be apparent to one skilled in the art that the above-mentioned various conversation forms and input means will be applied as the same or similar manner as the description of the specification.

An example of the intelligent information processing module according to an exemplary embodiment of the present invention includes a question analyzing unit 410, a conversation controller 420, information processing units 430 to 450, a media searching unit 460, a correct answer creating unit 470, and a communicating unit 480.

Hereinafter, the respective configuration of the intelligent information processing module according to the exemplary embodiment will be described in detail.

The question analyzing unit 410 analyzes the request of the viewer input from the digital television receiver, that is, question data and transmits the analyzed result to the communication controller 420. Here, the analyzing process analyzes primarily the input question data and reads out at least one object included in the question. Then, the question analyzing unit 410 secondarily analyzes at least one read-out object to confirm and read out a subject to be responded to the question data. In the process of confirming the subject of the question data, the question analyzing unit 410 confirms the subject by judging at least one of a type, a kind, restrictions on the object, and an answer type of the read-out objects to analyze the input question. However, in the process of confirming the subject, the input question may include various data required for figuring out the intention of the question or a final response in addition to the above examples.

Various methods may be used to analyze the input question data. For example, a method of using a structure of a corresponding language according to a predetermined language kind or type may be used. Specifically, input words or sentences are divided into a subject, an object, a predicate, and so on and then an object that is a specific analysis object is discriminated. Otherwise, a plurality of words, for example, vocabularies recorded in a dictionary is built and stored as a database, and the input text is compared with the stored vocabularies to extract a word that matches with the input text. Then, the meanings of the extracted word is combined and classified to discriminate the object that is the specific analysis object. Various methods for analyzing a text, which will be notified or applied in the future may be used.

The conversation controller 420 controls the information processing units using the analyzed result input from the question analyzing unit 410 to control pre-processes for collecting data to create an intelligent response that actively varies in real-time according to the intention of the question, that is, a reply that is the most suitable for the intention of the viewer (referred to as a “correct answer” in this specification). The conversation controller 420 further controls the information processing units to transmit the data collected for creating the correct answer to the answer creating unit 470, so that the created correct answer is provided to the viewer. For example, the conversation controller 420 classifies the analyzed results and then transmits the analyzed results to each of the information processing units. Furthermore, the conversation controller 420 may command to collect, store, and transmit the corresponding data. Hereinafter, the conversation controller 420 will be further described in the corresponding parts in detail.

Next, the information processing unit that collects and processes the data for configuring the correct answer in accordance with the control of the conversation controller 420 will be described in detail.

As described above, the information processing unit may include a first processing unit 430 that processes contents/reviews of a media, a second processing unit 440 that processes issues of the media, and a third processing unit 450 that processes broadcast contents. The information processing unit is illustrated to have three processing units, but is not limited thereto. The configuration of the information processing unit may be determined in consideration of the specification or efficiency of the system. For example, if the amount of materials for recently activated social media site is huge, an additional processing unit may be provided if required. Hereinafter, the respective processing units will be described.

Here, the media searching unit 460 is required to collect materials in the first processing unit 430 and the second processing unit 440 of the information processing unit in accordance with the control of the conversation controller 420, and searches social media site relating to the analyzed result and provides the searched social media site. In this case, the media searching unit 460 may categorize the searched social media site to provide the categorized social media site to the conversation controller 420 again, and then set or provide an environment that allows the selected social media site to be accessible in accordance with the control of the conversation controller 420.

The first processing unit 430 includes a first analyzing unit 436 that analyzes a review of another viewer that relates to a subject, which is an issue relating to a channel or broadcast contents that the viewer is currently watching, from the social media site searched by the media searching unit 460 and selected by the conversation controller 420, a first database 434 that stores contents analyzed in the first analyzing unit 436, and a first extracting unit 432 that extracts stored data analyzed by the first analyzing unit 436 from the first database 434 to transmit the extracted data to the conversation controller 420.

The analyzing unit 436 may use an algorithm similar to the analysis algorithm of the question analyzing unit 410 in order to search data from the social media site and analyze the searched data.

In the above description, the first database 434 classifies the analysis data input from the first analyzing unit 436 based on the predetermined criterion and stores the data as a database. The examples of the predetermined criterion may include a date, a day, a time, an issue, a genre, or a format. The issue includes a database of the analyzed data created based on an issue that is an analysis object, the genre includes a database of the analyzed data created based on a genre such as sports, dramas, cinema, or news, and the format includes a database created based on the format of the analyzed data such as audio, a text, a video, or an image.

Here, if the analyzed result with regard to the question data input by the question analyzing unit 410, that is, the correct answer request is received, the conversation controller 420 controls the first extracting unit 432 to extract required data from the database 434 to provide the data to the correct answer creating unit 470. Thereby, it is possible to respond (provide a correct answer) to the question input by the viewer. Even though not shown, if necessary, the conversation controller 420 may directly access the first database 434 to extract required data without using the first extracting unit 432.

The configurations and functions of the second and third processing units 440 and 450 are the same as or similar to those of the first processing unit 430. Therefore, only parts of the second and third processing units 440 and 450 different from those of the first processing unit 430 will be described and the description of the first processing unit will be cited or applied to a part that is the same as or similar to the first processing unit without describing separately.

An explorer 446 provided in the second processing unit 440 explores a new issue regarding the broadcast contents that are being watched by the viewer from the social media site 250, analyzes statistic information of the issue per time line, and stores the information into a second database 444. The stored data is extracted by a second extracting unit 442 in accordance with the control of the conversation controller 420 and then transmitted to the correct answer creating unit 470.

A second analyzing unit 456 provided in the third processing unit 450 analyzes various contents such as characters, a location, a story, and props of a program that is being currently broadcasted and stores the contents in a third database 454. The stored data is extracted by a third extracting unit 452 in accordance with the control of the conversation controller 420 and then transmitted to the correct answer creating unit 470. The third extracting unit 452 extracts a correct answer from broadcast program related index data stored in the third database 454 to transmit the correct answer to the conversation controller 420.

The conversation controller 420 transmits an answer including additional information in connection with the question and answer at the previous stage to the correct answer creating unit 470.

The correct answer creating unit 470 reads out a correct answer from data of the respective processing units 430 to 450 provided through the conversation controller 420, and creates a correct answer as a response for the question of the viewer by combining the read-out correct answer with at least one format of a text with a natural sentence, a graph, a table, audio, and a video corresponding to the question to transmit the created correct answer to the set-top box 224. Here, the set-top box 224 creates OSD data if required to output the correct answer transmitted from the correct answer creating unit 470 to provide the transmitted correct answer through the display 222.

The communicating unit 480 allows the viewer 210 to directly communicate with the social media site 250.

The above-described configuration of the respective processing units may perform their functions in accordance with the control signal of the conversation controller 420 or continuously update the stored data at a regular interval. When the stored data is continuously updated, the conversation controller 420 directly/indirectly accesses the databases 434, 444, and 454 of the respective processing units to directly extract required data, thereby more quickly responding to the question (request) of the viewer. Further, in the case of the respective databases 434, 444, and 454, the previous data is removed based on a predetermined rule at the time of updating the stored data to resolve the capacity related problems of the database. Further, in order to comply with the intelligent information processing process without missing the newest information, less effective data (invalid data) can be deleted.

In the above description, it is illustrated that the intelligent information processing module is included in the cloud or server 240. However, this invention is not limited thereto, and the intelligent information processing module may be included in the set-top box (STB) shown in FIG. 3. Accordingly, in this case, the function of the conversation controller 420 may be performed by a mycom or a native TV application manager provided in the set-top box (STB).

The example shown in FIG. 4 uses all of the first processing unit 430, the second processing unit 440, and the third processing unit 450. However, if necessary, the conversation controller 420 may not use any of the processing units 430 to 450. For example, it is described that the first processing unit 430 and the second processing unit 440 search and store the data and the issue from the social media site 250, and the third processing unit 450 analyzes and stores the data and the issue concerning the contents that are being broadcasted through the digital television receiver 220. However, other than the above function, the respective processing units may take charge of different social media site according to the settings, and analyze and store the related data from their corresponding social media site. Thereafter, the processing units combine the data extracted from the conversation controller 420 to provide correct answer data for a response to the correct answer creating unit 470. That is, the first processing unit takes charge of a first social media site, the second processing unit takes charge of a second social media site, and the third processing unit takes charge of another social media site such as an Internet café, so that the respective processing units extract data from their corresponding social media site to combine and process the extracted data.

Hereinafter, for more understanding of this invention, various scenarios that provide a broadcast service by the intelligent information processing according to the exemplary embodiment of the present invention are illustrated. However, it is apparent that the scope of the present invention is not limited to the scenarios or embodiments described above or to be described below.

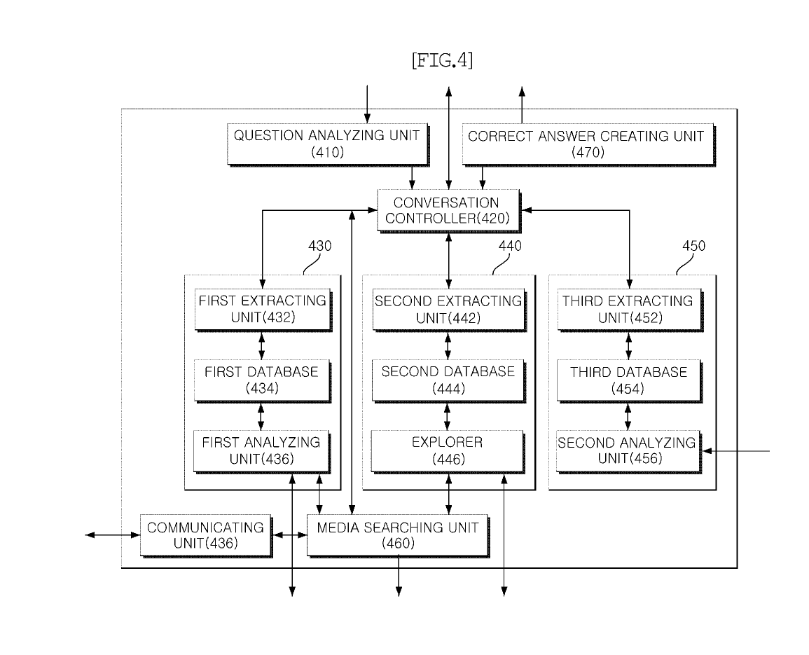

FIGS. 5 to 8 are diagrams illustrating examples of scenarios that are used in a broadcast service providing system for intelligently processing information according to an exemplary embodiment of the present invention.

FIG. 5 shows an example of scenarios that are used in a broadcast service providing system for intelligently processing information according to an exemplary embodiment. For example, it is assumed that while a viewer is watching a drama, he/she wants to know what type of smart phone an actor has in the drama. In this case, the intelligent information processing process according to the exemplary embodiment of the present invention will be described using the above-described system.

If the question analyzing unit 410 receives a question “what kind of smart phone does the actor A use?” from the set-top box, the question analyzing unit 410 analyzes the question and determines a subject that is a final answer format of the question to transmit the subject to the conversation controller 420. Here, in the analyzing process, priority objects may be the smart phone or the actor A. In case of determining the subject for the viewer's question based on the object, the question analyzing unit 410 confirms that the type of the question object is a smart phone, and the owner of the smart phone is the actor A, and, with reference to the remaining data of the question data, the subject of the question is the model type of the smart phone, and transmits to the conversation controller 420.

The conversation controller 420 transmits a control signal to the third extracting unit 452 on the basis of the question analysis contents and controls the third extracting unit 452 to extract appropriate data for the corresponding control data.

The third extracting unit 452 uses the question analysis contents to extract the correct answer “IPhone 4” from the third database 454 to return the extracted correct answer to the conversation controller 420.

The conversation controller 420 transmits the question analysis contents and the extracted correct answer to the correct answer creating unit 470. The correct answer creating unit 470 refers to the viewer's question to create a natural sentence corresponding to the viewer's question “the smart phone that A is using is an IPhone 4” as a correct answer to show the sentence to the viewer.

Here, the viewer can ask a continuous question relating to the provided correct answer. For example, if the viewer continuously asks a question “Is the smart phone good?”, the question analyzing unit 410 analyzes contents that the type of the object of the question is “smart phone” and the type of the correct answer is “review information on the smart phone” to transmit the analyzed contents to the conversation controller 420.

The conversation controller 420 additionally finds out the question analysis contents and a fact that the object of the question in the previous conversation is “IPhone 4” and transmits the analysis contents to the first extracting unit 432.

The first extracting unit 432 analyzes positive/negative review information of viewers regarding the IPhone 4 of social media site extracted from the first database 434 and extracts the review information per every attribute to return the extracted information to the conversation controller 420.

The conversation controller 420 transmits the received return contents to the correct answer creating unit 470.

The correct answer creating unit 470 creates a correct answer with a natural sentence and a table format using the question analysis contents and the extracted correct answer to show the correct answer to the viewer.

FIG. 6 shows another example of a scenario that is used in the intelligent information processing according to an exemplary embodiment. It is assumed in a situation that a viewer wants to compare broadcast contents with other broadcast contents while the viewer is watching the broadcast contents. In this case, the intelligent information processing process according to the exemplary embodiment of the present invention will be described using the above-described system.

If the question analyzing unit 410 receives a question “Which one is fun, Infinite Challenge or Two Days and One Night?” from the set-top box, the question analyzing unit 410 analyzes the question and determines a subject that is a final answer format of the question to transmit the subject to the conversation controller 420. Here, in the analyzing process, priority objects may be “Infinite Challenge”, “Two Days and One Night”, and a broadcasting program. The subject regarding the question of the viewer is determined using the objects. In this process, the question analyzing unit 410 confirms that the type of the question object is a broadcasting program, and the comparison objects are “Infinite Challenge” and “Two Days and One Night”. Further, with reference to the remaining data of the question data, the question analyzing unit 410 confirms and reads out that the subject of the question is the comparison result of the review of the two programs to transmit to the conversation controller 420.

The conversation controller 420 transmits the question analysis result to the first extracting unit 432 on the basis of the question analysis contents.

The first extracting unit 432 extracts review information by date for the two programs of the social media site from the first database 434 to return the extracted review information to the conversation controller 420. The conversation controller 420 transmits the correct answer to the correct answer creating unit 470.

The correct answer creating unit 470 creates a correct answer with a natural sentence and a graph format using the question analysis contents and the extracted correct answer to show the correct answer to the viewer.

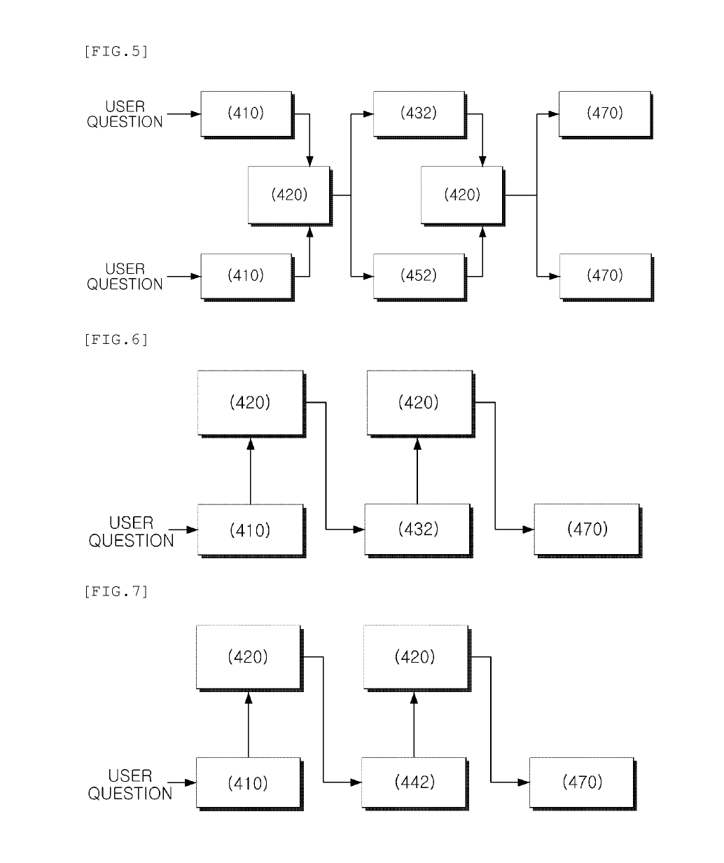

FIG. 7 shows another example of a scenario that is used in the intelligent information processing according to an exemplary embodiment. It is assumed in a situation that a viewer wants to know a general feature of broadcast contents. In this case, the intelligent information processing process according to the exemplary embodiment of the present invention will be described using the above-described system.

If the question analyzing unit 410 receives a question “Why is The King of Baking, Kim Tak-Gu fun?” from the set-top box, the question analyzing unit 410 analyzes the question and determines a subject that is a final answer format of the question to transmit the subject to the conversation controller 420. Here, in the analyzing process, priority objects may be “The King of Baking, Kim Tak-Gu” and a broadcasting program. The subject regarding the question of the viewer is determined using the objects. In this process, the question analyzing unit 410 confirms that the type of the question object is a broadcasting program. Further, with reference to the remaining data of the question data, the question analyzing unit 410 confirms and reads out that the subject of the question is the reason why the program is fun to transmit to the conversation controller 420.

The conversation controller 420 transmits the question analysis result to the second extracting unit 442 on the basis of the question analysis contents. The second extracting unit 442 extracts “interesting story” and “acting ability of actress Jeon In-Hwa” that are main issues of the corresponding program from the second database 444 to return the extracted information to the conversation controller 420, and the conversation controller 420 transmits the correct answer and the question analysis result to the correct answer creating unit 470.

The correct answer creating unit 470 creates a natural sentence using the question analysis result and the extracted correct answer to show the sentence to the viewer.

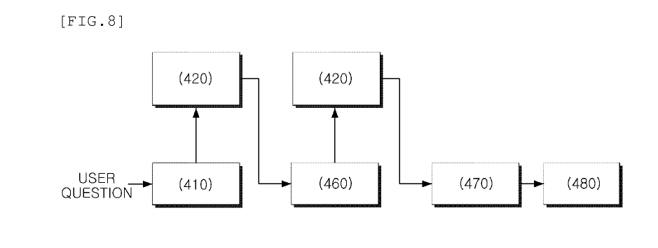

FIG. 8 shows another example of a scenario that is used in the intelligent information processing according to an exemplary embodiment. It is assumed in a situation that a viewer wants to write his/her own comments for a TV program on a social media site. In this case, the intelligent information processing process according to the exemplary embodiment of the present invention will be described using the above-described system.

If the question analyzing unit 410 receives a question “Please, find a social media site regarding “The King of Baking, Kim Tak-Gu” from the set-top box, the question analyzing unit 410 analyzes the question and determines a subject that is a final answer format of the question to transmit the subject to the conversation controller 420. Here, in the analyzing process, priority objects may be “The King of Baking, Kim Tak-Gu” and a broadcasting program. The subject regarding the question of the viewer is determined using the objects. In this process, the question analyzing unit 410 confirms that the type of the question object is a broadcasting program. Further, with reference to the remaining data of the question data, the question analyzing unit 410 confirms and reads out that the subject of the question is a social media ID to transmit to the conversation controller 420.

The conversation controller 420 transmits the question analysis result to the media searching unit 460 on the basis of the question analysis contents.

The media searching unit 460 searches the social media ID relating to the question from all of the entire social media sites to return the searched social media ID to the conversation controller 420. The conversation controller 420 transmits the correct answer and the question analysis result to the correct answer creating unit 470.

The correct answer creating unit 470 creates a natural sentence using the question analysis result and the extracted correct answer to show the natural sentence to the viewer and provide a screen for inputting the comments into the corresponding social media site. If the viewer inputs his/her comments onto the screen, the comments are stored in the corresponding social media site through the communicating unit 480.

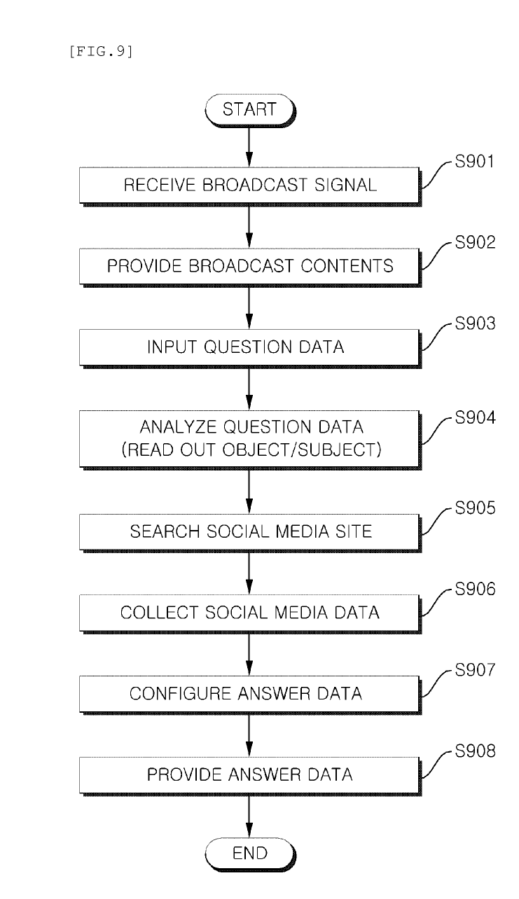

FIG. 9 is a flowchart showing an example of a broadcast service providing method according an exemplary embodiment of the present invention.

An example of an intelligent conversation processing method of an intelligent conversation processing system according to an exemplary embodiment of the present invention may be performed by conversation type question/answer processes as described below through a broadcast contents analysis and a related social media review analysis.

An example of the broadcast service providing method according to an exemplary embodiment of the present invention includes receiving a broadcast signal including broadcast contents and side information (step S901), providing the broadcast contents (step S902), receiving question data relating to the broadcast contents (step S903), reading out at least one object from the input question data, and analyzing the read-out object to read out a subject of the question data (step S904), searching a social media site (step S905), collecting social media data relating to the subject from the searched social media site (step S906), analyzing the social media data and the side information in the broadcast signal on the basis of the subject (step S907), and configuring and providing answer data corresponding to the subject using the analysis result (step S908).

The example of the broadcast service providing method according to an exemplary embodiment of the present invention may further include categorizing and providing the searched social media site, and selecting at least one social media site from the provided list of the social media sites. Further, the subject may be read out by further determining at least one of the type of the read-out objects, a category, restrictions on the object, and the type of the answer. Further, the provided broadcast service may be performed by using a cloud computing technology in the cloud or server. The format of the question and answer data may be at least one of a text, voice or audio, a gesture, a video, and an image or a combined conversation type of two or more thereof. Further, means for inputting the question data may include at least one of a remote controller, a local key, a keyboard, a microphone for inputting voice or audio, a smart phone, a mouse, a touch pad, a gesture inputting device, and a pointer, or a combination of two or more thereof. The social media data may include at least one of an issue relating to the read-out subject, review information, and information including words equal or similar to the subject. Further, the first analysis and the second analysis may use the same analysis algorithm. Storing the collected social media data as a database may be further included. The social media data may be made as a database based on at least one of a date, a day, a time, an issue, a genre, and a format.

As described above, according to the exemplary embodiments, it is possible to satisfy various demands of the viewers for the broadcast contents, provide a broadcast service including responses that are extended and varied in real time in response to the various demands of the viewers for the broadcast contents, not the fixed side information, and provide a broadcast service including conversation type information, thereby improving the satisfaction of the viewers.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for providing a broadcast service that provides information, which is extended and varied in real time, the method comprising:
receiving a broadcast signal including broadcast contents and side information to provide the broadcast contents;
reading out at least one of objects from question data that is input regarding the broadcast contents and primarily analyzing the read-out object to read out a subject of the question data;
searching a social media site and collecting social media data relating to the subject from the searched social media site;
secondarily analyzing the social media data and the side information in the broadcast signal on the basis of the subject; and
configuring answer data corresponding to the subject using the analysis result and providing the answer data.

2. The method of claim 1, further comprising:
categorizing and providing the searched social media site; and
selecting at least one social media site from the provided list of social media sites.

3. The method of claim 2, wherein the subject is read out by further determining at least one of a type of the read-out objects, a category, restrictions on the object, and a type of the answer.

4. The method of claim 2, wherein the provided broadcast service is performed using a cloud computing technology in a cloud or a server.

5. The method of claim 2, wherein the format of the question and answer data is at least one of a text, voice or audio, a gesture, a video, and an image or a combined conversation type of two or more thereof.

6. The method of claim 2, wherein means for inputting the question data is at least one of a remote controller, a local key, a keyboard, a microphone for inputting voice or audio, a smart phone, a mouse, a touch pad, a gesture inputting device, and a pointer or a combination of two or more thereof.

7. The method of claim 2, wherein the social media data includes at least one of an issue relating to the read-out subject, review information, and information including words equal or similar to the subject.

8. The method of claim 2, further comprising:
storing the collected social media data as a database.

9. The method of claim 8, wherein the social media data is made as a database based on at least one of a date, a day, a time, an issue, a genre, and a format.

10. A system for providing a broadcast service, comprising:
a digital television receiver configured to receive a broadcast signal including broadcast contents and side information, provide the broadcast contents, output question data that is input regarding the broadcast contents, and receive and provide answer data corresponding to the question data; and
a server including:
an analyzing unit configured to read out at least one of objects from the question data, primarily analyze the read-out object, and read out a subject of the question data from the read-out object through the primary analysis;
a searching unit configured to search a social media site;
a processing unit configured to collect social media data relating to the read-out subject from the searched social media site and secondarily analyze the social media data and the side information extracted from the broadcast signal on the basis of the subject to configure and output answer data corresponding to the subject using the analysis result.

11. The system of claim 10, wherein the searching unit categorizes and provides the searched social media site, and
the processing unit selects at least one social media site from the provided list of social media sites.

12. The system of claim 10, wherein the server provides the broadcast service using a cloud computing technology.

13. The system of claim 10, wherein the analyzing unit further determines at least one of a type of the read-out objects, a category, restrictions on the object, and a type of the answer to read out the subject.

14. The system of claim 10, wherein the format of the question and answer data is at least one of a text, voice or audio, a gesture, a video, and an image or a combined conversation type of two or more thereof.

15. The system of claim 10, wherein means for inputting the question data include at least one of a remote controller, a local key, a keyboard, a microphone for inputting voice or audio, a smart phone, a mouse, a touch pad, a gesture inputting device, and a pointer or a combination of two or more thereof.

16. The system of claim 10, wherein the social media data includes at least one of an issue relating to the read-out subject, review information, and information including words equal or similar to the subject.

17. The system of claim 10, wherein the server further includes:
a storing unit configured to store the collected social media data as a database.

18. The system of claim 17, wherein the storing unit makes the social media data as a database based on at least one of a date, a day, a time, an issue, a genre, and a format.
